(19) United States
(12) Patent Application Publication
(10) Pub. No.: US 2014/0265899 A1
(43) Pub. Date: Sep. 18, 2014

(54) Linear LED Driver

(71) Applicant: Laurence P. Sadwick, Salt Lake City, UT (US)

(72) Inventor: Laurence P. Sadwick, Salt Lake City, UT (US)

(21) Appl. No.: 14/218,919

(22) Filed: Mar. 18, 2014

Related U.S. Application Data
(60) Provisional application No. 61/800,677, filed on Mar. 15, 2013.

(51) Int. Cl. H05B 33/08

(52) U.S. Cl. CPC H05B 33/0812
USPC 315/200 R

(57) ABSTRACT

A linear driver circuit includes an AC input, a rectifier connected to the AC input, a linear power supply connected to the rectifier, a load output connected to the linear power supply, a current detector connected to the load output, and a controller connected to the current detector and to the linear power supply.

### BACKGROUND

Electricity is generated and distributed in alternating current (AC) form, wherein the voltage varies sinusoidally between a positive and a negative value. However, many electrical devices require a direct current (DC) supply of electricity having a constant voltage level, or at least a supply that remains positive even if the level is allowed to vary to some extent. For example, light emitting diodes (LEDs) and similar devices such as organic light emitting diodes (OLEDs) are being increasingly considered for use as light sources in residential, commercial and municipal applications. However, in general, unlike incandescent light sources, LEDs and OLEDs cannot be powered directly from an AC power supply unless, for example, the LEDs are configured in some back to back formation. Electrical current flows through an individual LED easily in only one direction, and if a negative voltage which exceeds the reverse breakdown voltage of the LED is applied, the LED can be damaged or destroyed. Furthermore, the standard, nominal residential voltage level is typically something like 120 V or 240 V, both of which may present issues for LED lights unless properly addressed. Some conversion of the available power may therefore be necessary or highly desired with loads such as an LED light.

Drivers or power supplies for loads such as an LED may be configured to provide a desired load current based on the expected line voltage. However, for example, in input overvoltage conditions, the load condition may rise unacceptably and damage the load.

### SUMMARY

A linear LED driver is disclosed that achieves high efficiency with current control over practical AC voltage ranges including, for example, 108 VAC to 132 VAC and 198 VAC to 242 VAC while providing protection to, for example, but not limited to, over-current and over-voltage and over-temperature faults and conditions, situations, etc. The present invention also works with DC input. For example, in some embodiments of the linear LED driver, a detection, feedback and control circuit controls, for example, a transistor or transistors (switches) to adjust the load current, control the current through the LEDs or load while still retaining high efficiency and high power factor (PF). The present invention is not limited to the example above and applies and can be applied to both linear and switching and a combination of functions in general including LED power supplies and drivers. Although current controlling, limiting and protection example embodiments are presented here, the present invention can also be used for other modes including power limiting. The embodiments shown and discussed are intended to be examples of the present invention and in no way or form should these examples be viewed as being limiting of and for the present invention.

This summary provides only a general outline of some particular embodiments. Many other objects, features, advantages and other embodiments will become more fully apparent from the following detailed description.

### BRIEF DESCRIPTION OF THE DRAWINGS

A further understanding of the various embodiments may be realized by reference to the figures which are described in remaining portions of the specification. In the figures, like reference numerals may be used throughout several drawings to refer to similar components.

FIG. 1 depicts a block diagram of an LED driver with a current control, high efficiency and limiting and protection in accordance with some embodiments of the invention.

FIG. 2 depicts a block diagram of an LED driver with dimmer, current control, high efficiency and limiting and protection in accordance with some embodiments of the invention.

FIG. 3 depicts another block diagram of an LED driver with a current control, high efficiency and limiting and protection in accordance with some embodiments of the invention.

FIG. 4 depicts a schematic of an example LED driver with a current control, high efficiency and limiting and protection in accordance with some embodiments of the invention.

FIG. 5 provides a schematic of an example LED driver with one or more stages of LEDs in accordance with some embodiments of the invention.

FIG. 6 provides a schematic of an example LED driver with a fixed output to a load such as LEDs or OLEDs in accordance with some embodiments of the invention.

FIG. 7 provides a schematic of an example LED driver that switches off the current/power to a load such as LEDs or OLEDs at a certain voltage point in accordance with some embodiments of the invention. Note that voltage 294 in FIG. 7 represents a voltage reference that can be derived from other parts of the embodiments.

FIG. 8 provides a schematic of an example a circuit which can be used to provide a pulse either directly or indirectly to the output load such as LEDs or OLEDs in accordance with some embodiments of the invention.

### DESCRIPTION

A current control and high efficiency with current and voltage limiting LED driver, which can also be used for applications and purposes and power supplies and drivers other than LED drivers, is disclosed that, for example, controls, limits and protects a load during both input non-dimming and dimming conditions. An overvoltage detector in the current control and limiting LED driver detects input overvoltage conditions and limits the load current. For example, in some embodiments of the current limiting LED driver, a feedback loop is used to control the current while still producing a high power factor at high efficiency at a constant load current. The present invention can also use voltage enhancement circuits such as disclosed in U.S. Patent Application 61/736,080, filed Dec. 12, 2012 for “Power Quality Enhancement” which is incorporated herein by reference for all purposes. Voltage enhancement circuits may be used, for example, in certain embodiments to enhance both power factor and reduce ripple. For example, a variable signal can be applied to a linear transistor or equivalent device that controls and or passes current to the load. During input overvoltage conditions, the overvoltage detector changes the voltage to certain elements and parts of the circuit effecting a change in, for example, the gate or base drive to the linear element which, in embodiments of the present invention, can turn off the linear transistor and the current through the load. Some embodiments of the present invention accomplish this by reducing the DC reference voltage and causing the on-time of the linear transistor to decrease and, in effect, act as a variable pulse generator during the AC cycle time. Such an effective variable pulse generator can produce simple to complex waveforms so as to control, manage, reduce, limit the load current. The present invention also provides high power factor.

Examples of LED drivers that may incorporate a current limiter and ripple reducer disclosed herein include those in U.S. patent application Ser. No. 13/404,514, filed Feb. 24, 2012 for a “Dimmable Power Supply”, in U.S. patent application Ser. No. 12/776,409, filed May 9, 2010 for a “LED Lamp with Remote Control”, in U.S. patent application Ser. No. 13/674,072 filed Nov. 11, 2012 for a “Dimmable LED Driver with Multiple Power Sources”, and in U.S. patent application Ser. No. 13/299,912 filed Nov. 18, 2011 for a “Dimmable Timer-Based LED Power Supply”, and in U.S. Patent Application 61/786,415 filed Mar. 15, 2013 for a “Ripple Reducing LED Driver” which are all incorporated herein by reference for all purposes. Such a driver provides power for lights such as LEDs of any type and other loads.

Certain embodiments of the linear LED driver do not require electrical re-wiring to install and work with electronic ballasts. No rewiring or special handling required. Embodiments of the present invention can be a direct replacement to be powered by ballasts in lighting fixtures and also for use in rewired fixtures where AC power is supplied directly to the lamps.

Turning to FIG. 1, a block diagram of an LED driver is depicted as an example application of a current controller, limiter and protection driver in accordance with some embodiments of the invention. A source 102 of AC input power typically at 50 or 60 Hz is either directly supplied to the input of an AC to DC rectification stage 104 or the AC input 102 is applied to a Triac, Triac-based, other forward or reverse dimmer (e.g., 116, FIG. 2), etc. for which the output of the such a dimmer is applied to the input of AC to DC rectification stage 104 of the present invention. The rectified voltage is then fed to a highly efficient linear regulator 106 which, in turn, feeds the load 112 as well as the control circuit 110. The load 112 can be monitored by a number of detectors including current and thermal (not shown) which feed information and signal(s) to the control unit 110. The control unit 110 also has voltage detection and protection such that the control unit 110 is able to adjust and control, as necessary, and even completely turn off current to the load 112 as required. Thermal protection can be accomplished by a number of methods including the use of pn junctions, bipolar transistors, negative or positive temperature coefficient thermistors, etc., which, in many cases, could be incorporated into an integrated circuit (IC).

In some embodiments, the control unit 110 provides programmable timed or sensor or event-based control, turning on and off current to the load, dimming the load, etc. as programmed. The control unit 110 is configured in some embodiments to set and/or store control functions and operations, i.e., scheduling, turn on/off, dim, respond to voice, motion, etc. at certain time(s) each day, multiple times per day, different days of the week, weekends, different dates including day date and month date, etc., in some cases with partial or full randomization of settings. The settings can be stored in any type of memory including volatile, non-volatile, random access memory (RAM), FLASH, EPROM, EEPROM, other semiconductor, magnetic, optical, etc. memories.

In some embodiments, the linear LED driver disclosed herein is configured as a monochromatic linear LED driver for use in photosensitive environments such as hospitals, clean rooms, etc., in which the color and/or intensity of light must be controlled, for example, to produce a particular red or amber light by adapting the control unit 110 to control multiple load outputs, or by replicating the driver circuit to control each of a number of differently colored loads. In some embodiments it may be extremely important to have monocolor or nearly monocolor/monochrome light with as close as possible to a single wavelength with, for example, a narrow full width at half maximum (FWHM) wavelength broadening. For example in certain areas of cleanrooms or other areas where photosensitive materials such as photoresist used for patterning which, for example, may be sensitive or partially or completely developed by exposure to wavelengths shorter than, for example, but not limited to, yellow and/or amber, etc. such as green or blue or ultraviolet, implementations and embodiments of the present invention allow such wavelength restrictions to be, for example, addressed, realized and enabled. In some embodiments of the present invention, filters may be used to restrict the wavelengths for uses in, for example, but not limited to photosensitive areas including hospitals, photographic film development, cleanrooms especially cleanrooms and other areas using photosensitive materials and/or photolithography and/or photolithographic processes. Such fluorescent lamp replacement (FLR) wavelength light control can be realized with and by a number of ways, technologies, materials, techniques, lamps, light sources, emitters, etc., including but not limited to, an LED, an OLED, arrays, strings, combinations of including in parallel and/or series of OLEDs and/or LEDs, combinations, groups, and/or subsets of these, which produce light only in the desired spectrum etc. In some other of these embodiments, two or more operating modes are provided, for example, to switch between a red or amber or output to a white output. In other embodiments, health effects of lights and lighting can be used with the present invention to assist in improved sleep, circadian rhythm regulation, control, reset, etc. by only using certain wavelengths at certain times in the circadian rhythm cycle to aid in sleep and circadian rhythm control. Dimming may also be employed as well as feedback on human factors to assist in health related matters including applying certain wavelengths and not applying certain other wavelengths at various times, dimming, not dimming, etc. to improve, for example, sleep, circadian rhythm, health performance, human and other animal behavior and performance, etc. To simulate and properly awake, etc. using the present fluorescent lamp replacement including with feedback such as that from electroencephalography (EEG), motor movement sensors, body temperature, including rectal temperature, biorhythms, motor movements, sleep sensors, sleep actigraphs (generally watch-shaped sensors worn on the wrist), polysomnography (PSG) sensors, etc., wherein any of these or other sensors generate an electrical control signal, either wired or wirelessly, to the fluorescent lamp replacement, and the fluorescent lamp replacement outputs a suitable color and/or intensity in response. For example, light can be dimmed, soothing colors can be generated, etc. Lighting can be controlled based on circadian rhythms detected in EEG feedback to enhance sleep. The color of the output light can be adapted based on such feedback, for example to avoid producing light in the blue portion of the spectrum to avoid suppressing melatonin before sleep. Example applications that benefit from such controlled lighting color and/or intensity include transportation means such, but not limited to, airplanes, boats, ships, submarines, busses, etc., dwelling or gathering places such as, but not limited to, hospitals, schools, school rooms, work places, nurseries and pre-school facilities, airports, etc., and light-deprived environments especially natural light-deprived environments including submarines, long airplane flights to assist with jet lag, etc.

The use of one or more linear regulators 106 with, for example, different maximum voltages can be set for individual regulators allowing, for example, current to only flow at prescribed times during an AC cycle, etc. may be included in various embodiments of the present invention. In addition an overvoltage detector (not shown) overrides the signal to the linear transistor element otherwise acts to reduce the current or turn off the current based on the input conditions and the maximum allowable/set current and voltage including if a parameter(s) exceeds that expected or reaches a level that would damage the load 112 or other components. Embodiments of the present invention also support dimming including the use of dimmers such as Triac dimmers while some embodiments are not intended to be Triac dimmable, whereas other embodiments can be dimmed wirelessly, wired, powerline control (PLC), and/or Triac dimmable. An example powerline connection interface that can be used to control the linear LED driver is disclosed in U.S. patent application Ser. No. 14/218,905, filed Mar. 18, 2014 for a “Powerline Control Interface”, which is incorporated herein by reference for all purposes. The block diagram depicted in FIG. 1 is intended to provide an example of the present invention and is in no way intended to be limiting in any way or form for the present invention.

Turning to FIG. 3, another block diagram of an alternate arrangement of an LED driver is depicted as an example application of a current controller, limiter and protection driver in accordance with some embodiments of the invention. An source 102 of AC input power typically at 50 or 60 Hz is either directly supplied to the input of an AC to DC rectification stage 104 or the AC input is applied to a Triac, Triac-based, other forward or reverse dimmer, etc. for which the output of the such a dimmer is applied to the input of AC to DC rectification stage 104 of the present invention. The rectified voltage is then fed to a highly efficient linear regulator 106 which may consist of one or more switches and which, in turn, feeds the load 112 as well as the control circuit 110. The load 112 can be monitored by a number of detectors including current and thermal (not shown) which feed information and signal(s) to the control unit 110. The control unit also has voltage detection and protection such that the control unit is able to adjust and control, as necessary, and even completely turn off current to the load as required. Thermal protection can be accomplished by a number of methods including the use of pn junctions, bipolar transistors, negative or positive temperature coefficient thermistors, etc., which, in many cases, could be incorporated into an integrated circuit (IC).

The use of one or more linear regulators with, for example, different maximum voltages can be set for individual regulators and/or switches allowing, for example, current to only flow at prescribed times during an AC cycle, etc. may be included in various embodiments of the present invention. In addition an overvoltage detector (not shown in the figure) overrides the signal to, for example, the linear transistor element and otherwise acts to reduce the current or turn off the current based on the input conditions and the maximum allowable/set current and voltage including if a parameter(s) exceeds that expected or reaches a level that would damage the load or other components. Embodiments of the present invention also support dimming including the use of dimmers such as Triac dimmers. The block diagram depicted in FIG. 3 is intended to provide an example of the present invention and is in no way intended to be limiting in any way or form for the present invention.

Turning to FIG. 4, an example schematic diagram of a LED driver is depicted as an example application of a current control, limiter and protector in accordance with some embodiments of the invention. An example linear driver version of the present invention is depicted in FIG. 4. For clarity, some elements of a typical driver including AC power sources, are not shown in FIG. 4. A transistor 198 which is driven by the controller shown in FIG. 4 sets the current to and through the load, drawing power, for example, from an AC input 150 which could include a dimmer such as a Triac, Triac-based, or other forward or reverse dimmers, through a rectifier 152, or in other embodiments from a DC source. Operational amplifier (op amp) or comparator 176, in conjunction with resistors 184, 186, 182 and 180 acts as a difference amplifier and compares, in this particular embodiment, the filtered current via RC time constant consisting of resistor 190 and capacitor 194 of the load 200 through resistor 196 to a fixed or variable voltage represented by voltage 192 in FIG. 4. Fixed or variable voltage 192 could be a voltage reference such as a bandgap reference and could be incorporated into and as part of an integrated circuit including an application specific integrated circuit (ASIC), a field programmable gate array (FPGA), a complex logic device (CLD), a microcontroller, a microprocessor, a digital signal processor (DSP), a state machine, an analog or digital circuit, analog to digital converter (ADC), digital to analog converter (DAC), etc, or combinations of these. Likewise with op amp 174 and voltage source 172 including but not limited to approaches, components, techniques, methods, parts, ICs, etc., discussed herein. In addition, the present invention can also be dimmed wirelessly by, for example, but not limited to, a wireless signal that communicates with a wireless receiver attached or incorporated/embedded/integrated into the linear driver. For example in FIG. 4, reference voltage 172 could consist of a digital to analog converter (DAC) that provides a controllable output thus allowing the voltage point at comparator (or op amp) 174 goes high and turns on transistor 174, which in turn, turns off regulator switch transistor via op amp 176. Such a DAC could be set and controlled by, for example, one or more of a circuit, microcontroller, microprocessor, FPGA, DSP, CLD, etc. which in turn is controlled by wirelessly, wired and/or PLC transmitted signals. In addition, a switch could be inserted elsewhere in the power path to open the circuit/regulator at a certain point, time, voltage during an AC or rectified AC cycle and be reset (closed) at the start of the next AC or rectified AC cycle. In many respects, in certain embodiments of the present invention such dimming would be similar in AC line waveforms as would a Triac and/or forward or reverse phase angle/phase cut dimmer. Such dimming could be viewed in certain aspects as phase cut dimming without the phase cut dimmer using embodiments of the present invention.

In the example embodiment of FIG. 4, comparator or op amp 174 in conjunction with resistors 166, 170 and fixed or variable reference 172 and transistor 162 form a voltage detection and protection circuit that effectively turns off the voltage to the gate (or base, if for example a BJT is used for transistor 198) of transistor 198 in the event of a fault condition including an overvoltage condition or, for example, being set to a cycle by cycle dimming level by a wireless, wired, PLC, or local signal such as a movable blade of a potentiometer that can be manually moved. Multiple such circuits as depicted by op amp 174 and associated parts and components may be used with the present invention either in discrete or integrated into a single (or multiple) ICs or ASICs, or other types of electronics including but not limited to those mentioned in this document. Such a detector and current limiter as illustrated in FIG. 4 adapts and modifies the control signal sent to transistor 198 or otherwise acts to change the time width and duration including the amplitude of the signal set to transistor 198 or turn off transistor 198 if the output current or detection voltage(s) exceeds that expected, allowed or reaches a level that would damage the load or other components.

The transistors 198, 162, 174 shown in FIG. 4 may be any suitable type of transistors or other devices, such as a MOSFET or bipolar transistor or field effect transistor of any type and material including but not limited to metal oxide semiconductor FET (MOSFET), junction FET (JFET), bipolar junction transistor (BJT), heterojunction bipolar transistor (HBT), Darlington transistor, insulated gate bipolar transistor (IGBT), etc, and can be made of any suitable material including but not limited to silicon, gallium arsenide, gallium nitride, silicon carbide, etc which has a suitably high voltage rating. An AC input 150, which could be the AC lines or a dimmer connected to the AC is rectified in a rectifier 152 such as a diode bridge and may be conditioned using a capacitor (not shown) which may be connected on the DC side of the bridge to reduce, for example, ripple and a fuse (not shown) and tranzorbs, transient voltage suppressors (TVSs), metal oxide varistors (MOVs), spark gaps, other transient protection and absorbers, etc. or similar device or devices may be used to protect the driver and wiring from excessive current due to short circuits, high voltage spikes or other fault conditions.

The bias supply may be set at any suitable voltage level and may be generated by any suitable device or circuit typically within the circuit and does not typically require an external or additional power source. The choice of symbols for the power/voltage sources shown in FIG. 4 do not and should not necessarily be interpreted to represent batteries or other stand-alone power supplies.

An inductor or inductors may be used as appropriate in the present invention to assist with the function of the present invention including reducing the output ripple. In some embodiments, the load loop is placed above the switch 198, in other embodiments, the load (i.e., LED and/or OLED) is placed below the switch 198. Other optional components such as capacitors, inductors, resistors and switches, etc. may be included in the driver for various purposes.

A voltage divider (not shown) may be also used to produce and/or assist in obtaining the desired load current when the DC input is at the expected normal voltage level. When the voltage at the DC input rises, for example during transients, if connected to an incorrect AC input, or due to any other overvoltage conditions, etc., the overprotection circuit illustrated by op amp 174 and associated components will act to protect the load from damage.

The current limiter can be controlled based on any desired signal representing a circuit condition, such as peak AC voltage. In the embodiment of FIG. 4, the current limiter may be controlled by a scaled representation of the AC voltage using, for example, resistors 166, 170 so if the current increases, the bias voltage increases, providing current control.

The LED driver powers and controls a load 200 such as one or more LED and/or OLED lights, from a power source such as a DC rail, which may be derived from an AC input using a rectifier. A transistor (i.e., 198 in FIG. 4) is controlled by a variable signal from, for example, the simplified circuit consisting of op amp 176 and associated components and the simplified circuit consisting of op amp 174 in FIG. 4 or other control circuit through, for example, a gate or base signal, blocking or allowing current to flow from the DC rail to a ground through the transistor. Again, in the example embodiment in FIG. 4, as current flows through the transistor 198, it also flows through the load 200 and resistor 196. When the transistor 198 is turned off by the control circuit, no current flows in the load of the schematic shown in FIG. 4. One or more optional capacitors may be connected in parallel with the load 200; an example of which is shown in FIG. 4.

In some embodiments of the present invention a pulse generator is incorporated. In other related embodiments, the control circuit generates a feedback signal to set the pulse width from the variable pulse generator, setting the load current at the desired level. A capacitor or capacitors or other time constant components may be used to average the voltage fluctuations for the feedback signal. The Current control and ripple reduction may include one or more time constants in any suitable location throughout the driver or distributed in multiple locations, and may be embodied in any suitable manner, not to be limited to example RC time constants disclosed herein. For example, the time constant consisting of resistor 190 and capacitor 194 in FIG. 4 can be chosen such that the operational amplifier and the effective feedback system can, under certain circumstances, break into controlled oscillation resulting in effectively a hybrid switching linear regulator.

The current limiter and ripple reduction monitors voltages and currents and adjusts the voltage of feedback signal(s) to modify the pulse width from the variable pulse generator. The current limiter and ripple reducer thus protects the LED load from conditions that might otherwise damage them. In other embodiments, such an arrangement may be used to produce a constant current over an extended range of either AC or DC input voltages.

Although a MOSFET is depicted in parts of schematic depicted in FIG. 4, any appropriate device, switch, etc. can be used including BJTs, MOSFETs, JFETs, other types of FETs, IGBTs, GaNFETs, SiCFETs, vacuum tubes including diodes, triodes, tetrodes, pentodes, etc. In some embodiments of the present invention, a variable pulse generator may be used in certain conditions to control the output circuit. Some of such embodiments include the capability for the transistor 198 to switch from acting essentially as a linear element to a switching element and, for these embodiments, the circuit takes on a dual hybrid nature of being either or both a linear and/or switching power supply.

Voltage, current, efficiency and power factor measurements for one example embodiment of the driver of FIG. 4 are set forth in Table 1. As can be seen from the data in Table 1, high efficiency, high current control and power factor can be obtained over a desirable AC input voltage range. Low harmonic distortion (THD) can also be obtained in embodiments of the present invention. By changing components including optimizing the LEDs and/or OLEDs used as the load, similar results can be obtained at other useful AC input voltage ranges including in the range of less than 200 VAC to greater than 240 VAC and above.

TABLE 1

| AC In | Normalized | Efficiency | Power |
|---|---|---|---|
| (V RMS) | Current | 1.00 = 100% | Factor |
| 105.29 | 0.9951 | 0.9807 | 0.9126 |
| 110.34 | 0.9933 | 0.9786 | 0.9207 |
| 115.31 | 0.9950 | 0.9783 | 0.9275 |
| 120.35 | 0.9993 | 0.9758 | 0.9335 |
| 125.41 | 1.0089 | 0.9739 | 0.9385 |
| 130.38 | 1.0259 | 0.9724 | 0.9429 |
| 135.44 | 1.0252 | 0.9704 | 0.9487 |
| 140.49 | 1.0256 | 0.9686 | 0.9490 |

In some embodiments, the load current is kept constant at the operating voltage via the detection, feedback and control, thus providing constant current for small voltage fluctuations and protection against large excursions including transients around the expected operating voltage.

FIG. 5 shows an example of what shall be referred to, for purposes of discussion, as a two stage linear regulator. Resistors 154, 156 are optional fuses or fuse resistors. Diode rectifier bridge 152 converts the AC input 150 to rectified DC. Resistor 172 and Zener diode 174 form a simple power supply that supplies voltage and power to much of the rest of the circuit. Resistor 184 and transistor 186, in conjunction with the level shifter 200, a supply switch and drive circuit for switch 176, to drive a transistor base (for a bipolar transistor) or gate (for a field effect transistor) for switch 176. The level shifter 200 is not included in some embodiments. The level shifter 200 can comprise any suitable device or circuit for shifting a level of an electrical signal. This supply switch and drive are controlled by the circuit consisting of resistors 220, 222, 214, 210 and transistors 212, 216 such that when the voltage at the junction of resistors 220, 222, which form a voltage divider, is sufficient to turn on switch 216, switch 212 turns off and the level shifter turns on such that switch 186 is turned off which, in turn, turns off switch 176 which, in turn, shuts down the supply of current to LED and/or OLED stack/array 160 (note the number of LEDs and/or OLEDs shown in FIG. 5 are representative and only for illustrative purposes). Again, such a level shifter is shown and depicted for illustrative purposes and not meant nor intended to limiting in any way or form. Resistor 202 and voltage 204 are representative only and not an actual implementation of an internal bias for this particular example embodiment. Switch 164, when turned on, provides a current path for LED and/or OLED stack/array 162. Switch 164 is turned down or turned off when the voltage across resistor 166 due to the current through resistor 166 is large enough to turn on transistor 170. Note, if transistor 170 is a bipolar transistor then transistor 170 can also act as an over-temperature protection since the base-emitter voltage decreases as temperature increases which, in turn, turns on transistor 170 at a lower voltage across resistor 166. Note resistor 180 is optional and, if used, is typically a low resistance value. Other methods may be used as an over-temperature protection, for example, thermistors in one or more locations that, for example, using FIG. 4, take the place of resistors 166, 170, and/or 196, etc. depending on whether the thermistors are negative temperature coefficient (NTC) or positive temperature coefficient (PTC), with the result in the voltage divider made up of 166, 170 to raise the voltage at the junction between 166, 170 or the voltage across resistor 196 to a higher voltage value as temperature increases. This can be accomplished by using a PTC thermistor for resistor 196 and/or a NTC thermistor for resistor 166 and/or a PTC thermistor for resistor 170. Numerous other methods can be used to provide over temperature protection including, but not limited to, bipolar transistors, pn junctions, circuits in an integrated circuit, etc. Embodiments and implementations of the present invention may replace resistors 180, 184, 202 and transistors 176 and 204 with other parts and components including a single transistor and/or switching component/element, etc. Although transistor 176 is shown in FIG. 8 as a BJT, FETs including MOSFETs may be used to replace transistor 176.

FIG. 6 shows an example of part of a linear driver in which resistors 234, 236 are optional fuses or fuse resistors, diode bridge 232 rectifies the AC from AC input 230 to DC, resistors 240, 254 and Zener diode 242 and transistor 252 act as a voltage regulator and resistors 244, 246 act as a voltage divider such that the drive to transistor 252 is limited or shut/turned off when the voltage at the junction of resistors 244, 246 is sufficient to turn on transistor 250 thus limiting the voltage for which the load (i.e., LEDs, OLEDs, and/or resistive or other loads) for which the load is actively being supplied power directly from the AC lines via rectifier bridge 232 (note that the load in FIG. 6 may be supplied by some other power source). Optional capacitance/capacitors may be added to the example embodiment shown in FIG. 6 such as capacitor 256. Note that the circuit shown in FIG. 6 is not intended in general to be the complete driver/regulator/power supply but to possibly supplement and add to the overall regulator circuitry. Over temperature could also be added to this part of the linear regulator by, again using either or both NTC and PTC thermistors, semiconductor (i.e., pn junctions, FETs) temperature sensors, limiters, etc., integrated circuit temperature sensors and protection, etc.

FIG. 7 shows and illustrates another example embodiment that can be used as part of the present invention in which resistors 274, 276 are optional fuses or fuse resistors, diode bridge 272 rectifies the AC from AC input 270 to DC, and resistors 280, 282 act as a voltage divider with the voltage of the junction between resistors 280, 282 fed to the non-inverting input of comparator (or operational amplifier) 292 which drives transistor 290 such that when transistor 290 is turned on current flows through the load 286 (i.e., LEDs and/or OLEDs). Voltage 294 is representative of a voltage reference which in some embodiments can be remotely set, programmed, modified, etc. including, but not limited to, by/via wireless, wired, powerline and local methods discussed herein. Diode 284 is an optional diode that, for example, may be used in certain implementations such as when the present invention is used with magnetic and other types of ballasts including electronic ballasts. In some embodiments of the present invention a shunt regulator may be used to regulate and limit the current through the load when a ballast, including an electronic ballast, is used. The current through the load is limited or completely shut/turned off when, for example, the voltage at the junction of resistors 280, 282 is sufficient to set the output of comparator (or operational amplifier) 292 so as to typically turn off transistor 290 thus limiting the voltage for which the load 286 (i.e., LEDs, OLEDs, and/or resistive or other loads) for which the load 286 is actively being supplied power directly from the AC lines 270 (or ballast output) via rectifier bridge 272 which in the case of a high frequency electronic ballast would need to be a high frequency bridge made up of discrete or integrated fast, ultrafast, etc. recovery diodes. Optional capacitance/capacitors may be added to the example embodiment shown in FIG. 7. Note that the circuit shown in FIG. 7 may not be the complete driver/regulator/power supply but, instead, used to possibly supplement and add to the overall regulator circuitry especially in terms of providing a main or master overvoltage and/or overcurrent protection, shutoff, limit, etc. Over temperature could also be added to this part of the present invention by, again using either or both NTC and PTC thermistors, semiconductor (i.e., pn junctions, FETs) temperature sensors, limiters, etc., integrated circuit temperature sensors and protection, etc. including for resistors 280 and/or 282 with resistor 280 being a NTC thermistor and resistor 282 being a PTC thermistor. Again, voltage 294 can represent a fixed voltage reference or a variable, programmable, selectable, etc. voltage reference that can be manually, locally or remotely set, programmed, controlled, etc. again, using potentiometers, encoders, decoders, wired, wireless, powerline, etc. methods, protocols, algorithms, approaches, etc.

FIG. 8 shows an example embodiment of a circuit that can be used to provide switching action for the present invention by having a pulse extended, delay, etc. Voltage 300 represents a typically internal voltage to supply power to timer 330 which could be a timer IC, a delay circuit, a pulse extender, a multivibrator, a one-shot, other such circuits and functions, etc. Such a timer IC could be, but is not limited to, a 555 timer or other timer in the 555 family such as a 556 timer IC, 557 timer, 558 timer, 7555 timer, other bipolar or CMOS timers, timers in general, etc., or other circuits or devices to perform the functions disclosed herein. Resistor 302 and Zener diode 304 represent a voltage regulator, however any other type of voltage regulator source can in general be used including, but not limited to, a bandgap reference, a voltage regulator, etc. Resistors 306, 310 act as a voltage divider with the voltage at the junction of resistors 306, 310 used to set the voltage reference to the non-inverting input of the comparator (or, for example, op amp) 320 such that when the input to the inverting input of the comparator (or, for example, op amp) 320 is higher than in magnitude than the non-inverting input, the output of the comparator (or, for example, operational amplifier) 320 falls from a high voltage level to a lower level sufficient to trigger, for example, the timer circuit 330. This provides a pulse output that turns on transistor 336 which in turn can be used to turn off a high voltage series switch, a shunt switch, or any other type of device or switch which may limit, shunt, prevent, shut off, etc. current and or voltage as needed for a particular application and implementation so as to typically provide switching action to regulate, for example, part or all of the present invention. As an example implementation and application, the circuit embodiment shown in FIG. 8 can be used as part of a series regulator for an AC line application such as, for example, a 60 Hz 120 VAC or a 50 Hz 220 VAC and/or 240 VAC, etc. application and as a part of a shunt regulator for an electronic ballast. Resistors 302, 306, 310 and Zener diode 304 could be replaced with, for example, a bandgap voltage ref or a programmable digital to analog converter which can be remote controlled including, but not limited to, any of the types and materials included within and herein this document. Resistor 322 is optional in many embodiments and implementations of the present invention. Resistor 334 is also optional in many implementations and embodiments of the present invention.

In FIG. 8, resistors 314, 316 act as a voltage divider such that the voltage at the junction of resistors 314, 316 provides a voltage to the inverting input of the comparator 320 and is merely shown as an example which could, for example, be a scaled replication/version/signal of the rectified AC input at feedback input 312 or could represent the voltage from a current sensor or one or more current sensors, etc. Note, in certain embodiments and implementations of the present invention the signals shown going to the respective inputs of the comparator (or operational amplifier) 320 are reversed so as to generate a pulse under the opposite conditions, i.e., the voltage reference is higher than the sensed signal. It should be noted that a timer which is triggered with a negative going transition to produce a pulse of a specified duration is shown and depicted in FIG. 8; however, in general, any type of timer, many types of oscillators, multivibrators including monostable multivibrators and astable multivibrators, in general monostable oscillators, extended pulse, pulse elongate/generator, etc. may be used to achieve the function and performance illustrated in FIG. 8. The pulse duration is chosen to allow proper control of the load current or currents for certain implementations and embodiments of the present invention. In general, the pulse is set to be long enough to limit the current and allow the respective switch or switches to operate in a quasi, hybrid, standard, or typical, etc. digital or digital-like switching mode to, for example, but not limited to, avoiding excessive power dissipation in the respective switching element(s) while still keeping the current regulated. Resistors 334, 324 as well as capacitors 332, 326 are typically, in general, specific to the type of timer 330 used to achieve the pulsed switching performance.

Embodiments of the present invention can be combined together either partly or completely and can provide current and power regulation to loads such as LEDs and OLEDs for AC line voltage, DC output voltage (or current), portable power source(s), solar power source(s), magnetic and electronic ballast outputs, etc. as inputs to the embodiments and implementations of the present invention. In some embodiments and implementations of FIG. 8, resistor 340 may be used as a current sense resistor for feedback, monitoring, sense, control, etc. purposes.

It should be noted that the various blocks shown in the drawings and discussed herein may be implemented in integrated circuits along with other functionality. Such integrated circuits may include all of the functions of a given block, system or circuit, or a subset of the block, system or circuit. Further, elements of the blocks, systems or circuits may be implemented across single or multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

The above examples illustrate example implementations and embodiments and are not to be construed as limiting in any way or form.

There can be a combination of op-amps and comparators. One or more of the op amps shown in FIG. 4 may be replaced with a comparator including digital comparators, analog comparators, microcontroller comparators, microprocessor comparators, DSP comparators, FPGA comparators, digital to analog converter(s) (DAC) and analog to digital converter(s)(ADC) and any other type of analog and/or digital device or devices, circuits, etc. that can perform such functions. A current monitor (i.e., a sense resistor or winding which can also be used for other purposes including providing power to certain parts of the driver) can be used to limit the current and reduce the output ripple to the load, etc. The sense resistor can, for example, sense current or voltage or power either directly or indirectly. The present invention can, for example, be made to provide analog, digital, pulse width (PWM), duty cycle, etc. control of the output of the power supply under conditions of, for example, overvoltage, overcurrent, over-temperature, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc. Valley fill, doublers, triplers, quadruplers, as well as other multipliers and other PF enhancement, total harmonic distortion (THD) reducers, and/or ripple reducer enhancement circuits may be used and incorporated into the present invention including those in U.S. Patent Application 61/736,080, filed Dec. 12, 2012 for “Power Quality Enhancement”.

The example embodiments disclosed herein illustrate certain features of the present invention and are not limiting in any way, form or function of the present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. Embodiments of the present invention can be embodied/fabricated/manufactured in an integrated circuit or multiple integrated circuits. The present invention can include any type of switching elements including, but not limited to, field effect transistors (FETs) such as metal oxide semiconductor field effect transistors (MOSFETs) including either p-channel or n-channel MOSFETs, junction field effect transistors (JFETs), metal emitter semiconductor field effect transistors, etc. again, either p-channel or n-channel or both, bipolar junction transistors (BJTs), heterojunction bipolar transistors (HBTs), high electron mobility transistors (HEMTs), unijunction transistors, modulation doped field effect transistors (MODFETs), etc., again, in general, n-channel or p-channel or both, vacuum tubes including diodes, triodes, tetrodes, pentodes, etc. and any other type of switch, etc. The present invention can also be used with LED or OLED drivers designed for continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs.

Although in some examples discussed herein, one or two stages of load control/separation/etc., N stages where N>1 and can be as large as practical or needed and where some of the N stages may be modified or different from the other stages are used in some embodiments and implementations of the present invention. (The term “stages” is used here to refer to multiple load or LED groups and associated circuits (e.g., 160, 162) that can be switched on or off at different portions of the input AC cycle, for example but not limited to, dependent on the input power phase angle and/or voltage.)

Embodiments and implementations of the present invention can also accept and be used with universal voltage inputs from, for example, AC input voltages from 80 VAC to 305 VAC (or higher) including nominal 100 VAC, 120 VAC, 220 VAC, 240 VAC, etc. using for example, but not limited to, voltage multipliers including doublers, triplers, quadruplers, etc., synchronous rectifiers, transformers including, but not limited to, 50/60 Hz transformers, voltage tapped transformers, switching transformers, flyback transformers, forward converters with transformers, buck, boost, buck-boost, boost-buck, Cuk, etc. For example, a voltage doubler may be used which typically consists of two diodes and two capacitors to double the AC voltage input from, for example, 110 VAC to 220 VAC, or 120 VAC to 240 VAC. Such a doubler can be electronically disabled and replaced with a full wave bridge by electronically switching in/inserting a diode across each of the two capacitors so as to eliminate the voltage doubling action when, for example, the AC input source is 220 VAC or 240 VAC instead of, for example, 100 VAC to 120 VAC. Such disabling can be done automatically, for example, by sensing the AC input voltage by, for example but not limited to, measuring and determining the peak, root mean square (RMS), etc. voltage or by other means. In addition, other automatic, manual, remote including wireless, wired and other methods, approaches, ways, techniques, algorithms, etc. discussed herein and otherwise known may also be used.

Communications may include, but not limited to, SPI, U2C, WiFi, WiMax, Bluetooth, etc. Some embodiments may be dual dimming, supporting the use of a 0-10 V (or other voltage range including, but not limited to, 0 to 3 V, 0 to 5V, 1 to 8 V, 1 to 8 V, 0 to 1 V, etc.) dimming signal(s) in addition to a Triac-based or other phase-cut or phase angle dimmer. Other embodiments may be multi-dimming (i.e., two or more dimming modes, controls, features, etc.). Phase angle based and voltage based switching for output regulation and dimming can be controlled by any suitable device, such as, but not limited to, an application specific integrated circuit (ASIC), a field programmable gate array (FPGA), a complex logic device (CLD), a microcontroller, a microprocessor, a digital signal processor (DSP), a state machine, an analog or digital circuit, analog to digital converter (ADC), digital to analog converter (DAC), etc, or combinations of these. In addition, the resulting dimming, including current or voltage dimming, can be either PWM (digital) or analog dimming or both or selectable either manually, automatically, or by other methods and ways including software, firmware, remote control of any type including, but not limited to, wired, wireless, PLC, RS232, RS422, RS485, DMX, DALI, WiFi, Bluetooth, Z-wave etc. Embodiments of the present invention can use, for example, but not limited to any or all of wired, wireless, optical, acoustic, voice, sound, gesturing, mechanical, vibrational, and/or PLC, etc., combinations of these, etc. remote control, monitoring and dimming. Remote interfaces include, but are not limited to, 0 to 10 V, 0 to 2 V, 0 to 1 V, 0 to 3 V, etc., RS 232, RS485, DMX, DALI, WiFi, Bluetooth, ZigBee, IEEE 802, two wire, three wire, SPI, I2C, PLC, and others discussed in this document, etc., SPI, I2C, universal serial bus (USB), Firewire 1394, etc.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A driver circuit, comprising:
an AC input;
a rectifier connected to the AC input;
a linear power supply connected to the rectifier;
a load output connected to the linear power supply;
a current detector connected to the load output; and
a controller connected to the current detector and to the linear power supply.
